(19) United States
(12) Patent Application Publication
(10) Pub. No.: US 2012/0036439 A1
(43) Pub. Date: Feb. 9, 2012

(54) METHOD AND SYSTEM FOR MESSAGE TRANSMISSION AND DISPLAY IN COMPUTING DEVICE

(75) Inventor: Kuo-Feng HSIAO, Taipei City (TW)

(73) Assignee: INSIGHTEK CORP., Xizhi City (TW)

(21) Appl. No.: 12/851,765

(22) Filed: Aug. 6, 2010

(51) Int. Cl. G06F 15/16; G06F 3/048

(52) U.S. Cl. 715/733

(57) ABSTRACT

A method and system for message display and transmission in a computing device are disclosed. The method includes a step of determining whether a storage unit of the computing device stores at least a set of communication data or not. If the storage unit does not store the communication data, then the communication data would be downloaded from a server to the computing device and be stored in the storage unit. Moreover, the communication data is displayed by a display device of the computing device according to a particular procedure executed by the computing device.

### BACKGROUND OF THE INVENTION

1. Field of the Invention

The present invention relates to a method and a system for retaining, timing delivery, and displaying communications; in particular, to a method and a system for retaining, timing, and displaying communication messages in a system including a computing device and a display device.

2. Description of Related Art

To successfully promote various products, many companies and enterprises use communication messages to provide information concerning uses, applications, availability, effects, and the like of goods, services, articles of trade, and commodities in a manner to attract people's attention and boost sales. Typically, there exist multiple channels allowable for communicating means of encouraging understanding, generally communicating, and providing information including advertising or advertising publications, such as bulletin boards, direct mail (DM), television commercials, or add-on information occurring on web pages for computer browsers, with each advertisement channel or venue characterizing its own respective advantages and weaknesses.

Additionally, as computers are now becoming more and more widely applied, almost each person has his/her own personal computing systems and display device, such as a computer, and people are little by little getting used to long-time use of the computing device for all manners of working or recreational purposes, thus considering the computing device as one of the indispensible tools for the daily lives of most individuals. Among the currently available approaches for advertising communication through computing systems and their display devices, the computing device is essentially to show related or extra information to allow a user to view or select from that information when the user is browsing a webpage. Aside from this, other potential applications directed to advertising communications through or over computer systems and their display devices are rare and insufficient, thus the communication resources is imperceptibly wasted.

### SUMMARY OF THE INVENTION

An important object of the present invention is to provide a method and a system for receiving, retaining, timing, delivering, and displaying communications in a computing device or system and display device therein. When such a system or computing device executes a specific procedure, it is possible to show the predetermined communication or other message by the display device for watching by a user, thereby enabling more comprehensive and effective communication or communicating applications in the computing device.

According to a scheme of the present invention, a method for message display and transmission in a computing device is disclosed. In which the computing device is connected to a server through a network connection, and includes a storage unit and a display device. The method comprises steps of providing at least a set of communication data to the storage unit of the computing device, and displaying the communication data which should be currently displayed by the display device according to a schedule data and a specific procedure executed by the computing device.

The specific procedure may be a Basic Input/Output System (BIOS) execution procedure, an Operating System (OS) preparation procedure, or an OS execution procedure. For example, when the computing device runs the BIOS execution procedure, the communication data which should be currently displayed is simultaneously displayed by the display device in place of the original execution screen of the BIOS execution procedure. When the computing device runs the OS preparation procedure, the communication data which should be currently displayed is simultaneously displayed on the display device in place of the original preparation screen of the OS preparation procedure. Moreover, when the computing device performs the OS execution procedure, the communication data which should be currently displayed is simultaneously displayed in a display area shown by the display device.

In addition, the disclosed method further comprises a step of determining whether or not the storage unit of the computing device stores the communication data which should be currently displayed based on a schedule data. If the storage unit does not store the communication data which should be currently displayed, the communication data to be currently displayed is downloaded from a communication database of the server to the computing device and is stored in the storage unit.

Additionally, the method further comprises a step of determining whether or not to pre-download the communication data which is scheduled to be displayed but the corresponding display date is not yet arrived according to the schedule data. If it is not necessary to pre-download the communication data scheduled to be displayed, the determination step ends. On the other hand, if it is required to pre-download the communication data scheduled to be displayed, the method then goes to determine whether or not the storage unit already stores the communication data scheduled to be displayed. If the storage unit does not store the communication data scheduled to be displayed, then the communication data scheduled to be displayed will be downloaded from the communication database of the server to the computing device and be stored in the storage unit.

Moreover, the method may also comprises a step of determining whether or not the display date of the communication data scheduled to be displayed is arrived according to the schedule data. If the display date corresponding to the communication data scheduled to be displayed is arrived, the communication data scheduled to be displayed is then displayed at the display device.

According to another scheme of the present invention, a method for message display and transmission in a computing device is disclosed. Wherein the computing device is connected to a server through, and comprises a storage unit and a display device. The disclosed method comprises steps of providing at least a set of communication data to the storage unit of the computing device, and displaying the communication data on the display device according to a specific procedure executed by the computing device.

The method may also comprise a step of determining whether or not the storage unit of the computing device stores at least a set of communication data. If the storage unit does not store the communication data, the communication data is then downloaded from a communication database of the server to the computing device and is stored in the storage unit.

According to another scheme of the present invention, a system for message display and transmission is disclosed. The system comprises a server and a computing device. In which the server having a communication database which stores at least a set of communication data. The computing device is connected to the server through a network connection and has a display device, a storage unit and a display control unit. In which the communication data stored at the server is downloaded and stored in the storage unit through the network connection, and the display control unit determines whether or not the communication data is displayed by the display device according to a specific procedure executed by the computing device.

By downloading the communication data from the server and having it displayed for watching by users when the computing device runs a specific procedure, it is possible to fully exploit the display and communication resources of the computing device. Thus the communications for promoting and entertaining are improved.

The aforementioned summary and subsequent detailed descriptions are all intended to further illustrate the technical means and achieved effects of the present invention. However, the embodiments and drawings disclosed herein are simply as references, and are not for limiting the scope of the present invention.

### BRIEF DESCRIPTION OF THE DRAWINGS

FIG. 1 shows a block diagram of a system for message display and transmission according to an embodiment of the present invention;

FIG. 2 shows a schematic diagram when the communication data is displayed according to an embodiment of the present invention;

FIG. 3 shows a flowchart of a method for displaying and transmission in a computing device according to an embodiment of the present invention;

FIG. 4 shows a flowchart of a method for displaying and transmission in a computing device according to another embodiment of the present invention; and

FIG. 5 shows a flowchart of a method for displaying and transmission in a computer device according to still another embodiment of the present invention.

### DETAILED DESCRIPTION OF THE PREFERRED EMBODIMENTS

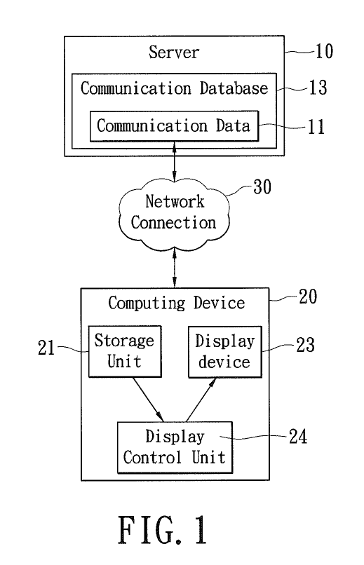

Referring to FIG. 1, which is a block diagram of a system for display and transmission according to an embodiment of the present invention. The system comprises a server 10 and a computing device 20. The computing device 20, such as a computer, a personal digital assistant (PDA), or other electronic device, is connected to the server 10 through a network connection 30.

The server 10 may be a host server for providing communications and includes a communication database 13 storing at least a set of communication data 11, such as messages, information, or advertisement. The computing device 20 is connected to the server 10 through the network connection 30. If the storage unit 21 of the computing device 20 does not have the communication data 11 in it, the communication data 11 will then be downloaded to the computing device 20 and stored in the storage unit 21. At the time when the computing device 20 runs a specific procedure, the communication data 11 will simultaneously be displayed on the display device 23 of the computing device 20, such as a screen installed with the computing device 20.

The storage unit 21 may be a Flash memory or a hard disk drive and the like. The computing device 20 may further include a display control unit 24 coupled to the storage unit 21 and the display device 23. Of course, it is also possible that the communication data 11 is displayed on the display device 23 of the computing device 20 directly through transmissions over the network connection 30 when it is required to be displayed without storing in the storage unit 21. Therefore, the above mentioned implementations do not tend to limit the scope of the present invention.

In the present embodiment, the system for message display and transmission may have a program stored in the server 10 or the computing device 20, for enabling the computing device 20 to communicate with the server 10 during the processes when the computing device is starting-up or shutting-down, and for determining whether the storage unit 21 stores the communication data 11 or not. If the determination result is negative, the program then controls the computing device 20 to download the communication data 11 from the server 10.

Particularly, the communication data 11 each may be correspondingly configured with a display date and time recorded in a schedule data. Thus, it is possible to determine whether or not a communication data 11 should start to be displayed on the display device 23, or to determine whether the communication data 11 is overdue or not according to the recorded schedule data. In which the schedule data may be stored at the server 10 or the computing device 20 and so on, but not limited thereto, and used to determine whether it is allowed to display the communication data 11 or else the display duration of the communication data 11 ends. Specifically, the determination associated with time may be performed based on a server time referred by the server 10, to prevent intentional modification of time/date of the computing device 20 by the user which may lead to erroneous determination of the display dates and durations.

In the present embodiment, some of the communication data 11 in the communication database 13 may be pre-stored into the storage unit 21, such as storing the communication data 11 scheduled to be displayed but the corresponding display dates are not arrived. In which the display date and time, such as starting date and end date, are recorded in the schedule data. Hence, according to the schedule data, the computing device 20 may download in advance the communication data 11 scheduled to be displayed before the display date is arrived, for avoiding network congestions among the network connection 30 caused by overly heavy transmission loads between the server 10 and multiple computing devices 20 within a short period of time. However, the computing device 20 may download the communication data 11 right on the display date as well, and is not for limiting the scope of the present invention.

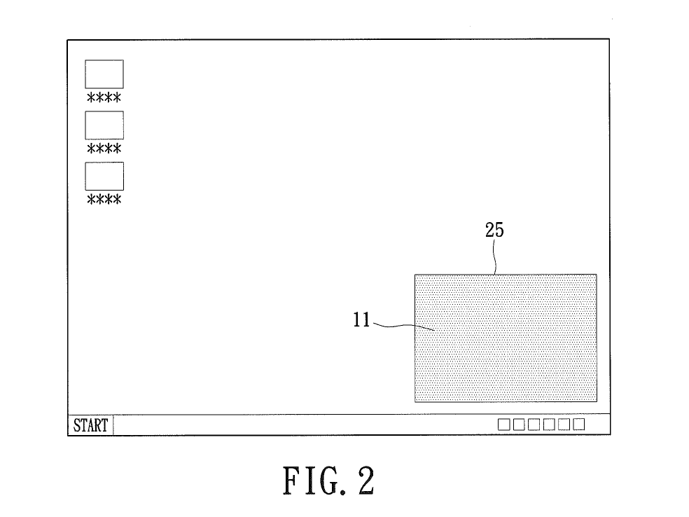

The display control unit 24 of the computing device 20 is used to display the communication data 11 when the computing device 20 executes the specific procedure. For example, such a specific procedure may be a Basic Input/Output System (BIOS) execution procedure. That is, when the computing device 20 is powered on and boots up the BIOS, the communication data 11 is displayed by the display device 23 for watching by the user, and the original BIOS execution screen is replaced by the display of the communication data 11. Alternatively, the specific procedure may be an Operating System (OS) preparation procedure, e.g., a preparatory login screen for Windows® or Linux OS initializations, and the communication data 11 is displayed in place of the original preparation screen of such OS. Moreover, the specific procedure may be an OS execution procedure. In this case, after the user entering into the OS, the communication data 11 is displayed in a certain area on the screen, as shown in FIG. 2. In this embodiment, the communication data 11 is shown in a display area 25 located at the lower right corner of the display screen.

It should be noted that the communication data 11, such as an advertisement data, displayed in the aforementioned examples may include “marquee” display, which means a plurality of communication data 11 can be cyclically displayed. Besides, displaying the communication data 11 may be set as compulsorily required, which may not be closed nor cancelled by the user.

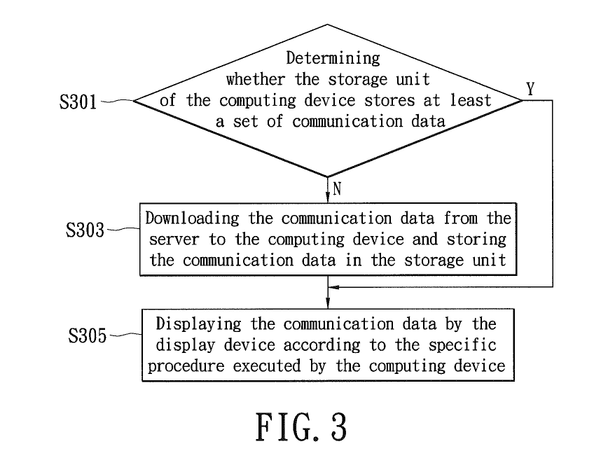

Referring next to FIG. 3, which is a flowchart of the method for message display and transmission according to an embodiment of the present invention. The method comprises the steps of determining whether or not the storage unit 21 of the computing device 20 stores at least a set of communication data 11, such as messages, information, or advertisement data (S301). In which the time when such a determination being executed may be at the startup or shutdown stage of the computing device 20. If the determination result is NO, then downloading the communication data 11 to the computing device 20 and storing it in the storage unit 21 (S303). The communication data downloaded may be texts, graphs, images, or audio/video data, etc., and the storage unit 21 may be a Flash memory or a hard disc drive, etc.

After that, according to the specific procedure executed by the computing device 20, the communication data 11 is displayed by the display device 23 (S305). The specific procedure may be a BIOS execution procedure, in the present embodiment, the display of the communication data 11 replaces the original execution screen when the BIOS is running. It is noted that while displaying the communication data 11, the execution of the BIOS procedure is still implemented. Alternatively, the specific procedure may be an OS preparation procedure, which changes the preparation screen shown at the OS initialization stage into the communication data 11. Moreover, the specific procedure may be an OS execution procedure. After the computing device 20 has completed login into the OS, the communication data 11 will be displayed in a certain area of the display device 23. As shown in FIG. 2, in which the communication data 11 is displayed in a display area 25 at the lower right corner of the screen.

It is noted that, in the present embodiment, the display of the communication data 11 may be configured as a compulsorily executed procedure, which can not be closed nor cancelled by the user of the computing device 20.

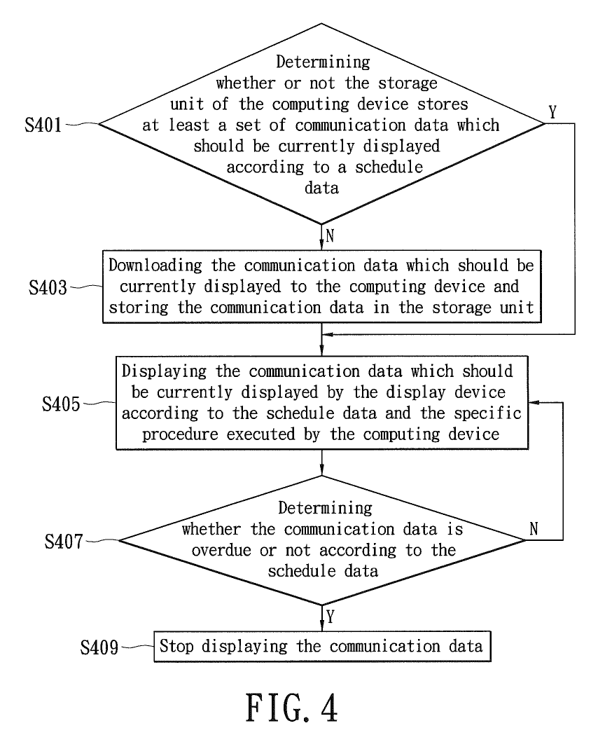

Please refer to FIG. 4, which is a flowchart of a method for message transmission and display in a computing device according to an embodiment of the present invention. The method comprises steps of determining whether or not the storage unit 21 of the computing device 20, such as a computer, a personal digital assistant (PDA), or other electronic device, stores at least a set of communication data 11 (such as messages, information, or advertisement) which should be currently displayed according to a schedule data (S401), in which the manner for determining the status of the communication data 11 may include comparing a display starting time recorded in the schedule data with a server time referred by the server 10, for deciding whether or not the communication data 11 is a set of communication data 11 which should be currently displayed.

If the determination result indicates that the storage unit 21 does not store the communication data 11 which should be currently displayed, then the step does to download the communication data 11 which should be currently displayed to the computing device 20 and store the communication data 11 in the storage unit 21 (S403). According to the schedule data and the specific procedure executed by the computing device 20, the communication data 11 which should be currently displayed is shown by the display device 23 (S405). The specific procedure may be a BIOS execution procedure, an OS preparation procedure, or an OS execution procedure. It is noted that a plurality of communication data 11 can be displayed at the same period of time, e.g., through a circulated display mechanism, to cyclically display a plurality of communication data 11. Additionally, in the present embodiment, the display of the communication data 11 may be set compulsory, which may not be cancelled by the user of the computing device 20.

As well as, the method may further comprise the steps of determining whether or not the communication data 11 is overdue according to the schedule data (S407). If it is overdue, then the display of the communication data 11 stops (S409). The determination step in S407 may be done by comparing the server time referred by the server 10 with the time recorded in the schedule data, to prevent intentional modification of time/date on the computing device 20 by the user which may lead to erroneous determination of the display schedule of the communication data 11.

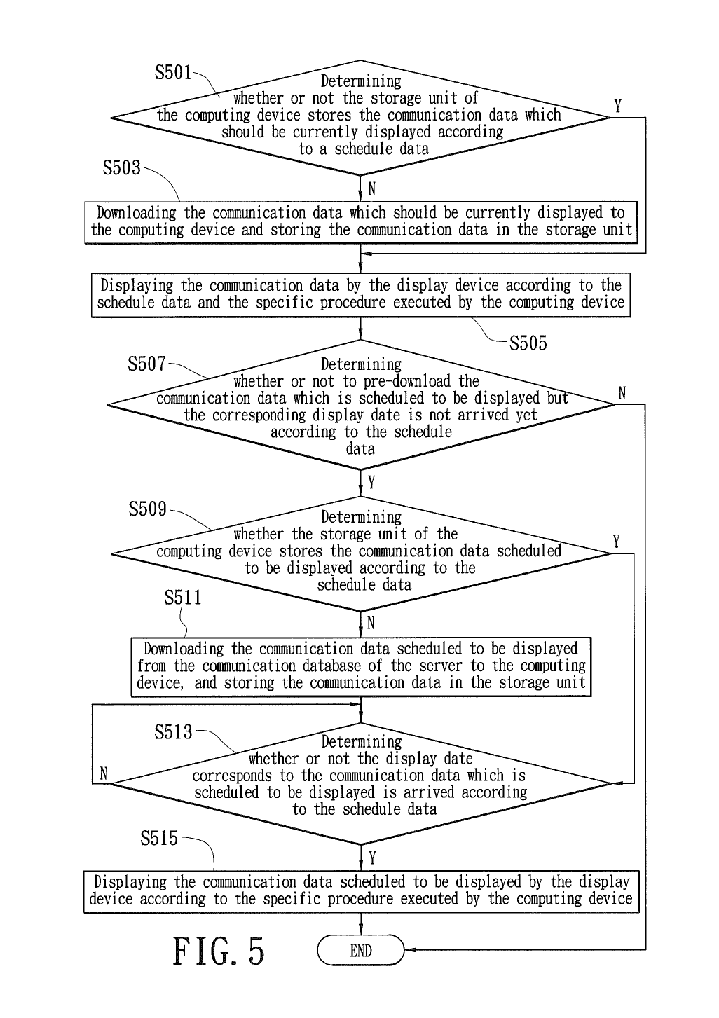

Referring to FIG. 5, which is a flowchart of a method for message display and transmission in a computing device, such as a computer, a PDA, or other electronic device, according to an embodiment of the present invention. The method comprises the steps of determining whether or not the storage unit 21 of the computing device 20 stores the communication data 11, such as an advertisement data, to be currently displayed according to a schedule data (S501). If the determination result is NO, downloading the communication data 11 which should be currently displayed to the computing device 20 and storing in the storage unit 21 (S503). After that, the method goes to display the communication data 11 at the display device 23 according to the schedule data and the specific procedure executed by the computing device 20 (S505).

In this embodiment, the method further comprises the steps of determining whether or not to pre-download the communication data 11 which is scheduled to be displayed but the corresponding display date is not yet arrived according to the schedule data (S507). If the communication data 11 scheduled to be displayed does not need to be pre-downloaded, the determination ends. On the other hand, if the determination result is YES, then a pre-download procedure is executed. In which the communication data 11 scheduled to be displayed may be downloaded to the computing device 20 after the schedule is arrived, or otherwise, as in the present embodiment, may be pre-downloaded to the computing device 20 and will not be displayed until the schedule is actually arrived.

The aforementioned pre-download procedure further includes the step of determining whether or not the storage unit 21 of the computing device 20 stores the communication data 11 scheduled to be displayed (S509). If the determination result is NO, then downloading the communication data 11 scheduled to be displayed from the communication database 13 of the server 10 to the computing device 20 and storing it in the storage unit 21 (S511).

Additionally, the present embodiment further comprises the steps of determining whether or not the communication data 11 scheduled to be displayed is allowed to be displayed (S513). If the determination result is YES, then displaying the communication data 11 scheduled to be displayed by the display device 23 according to the specific procedure executed by the computing device 20 (S515). As mentioned above, the determination in step S513 may be performed by comparing the display time recorded in the schedule data with the time referred by the server 10, to decide whether the communication data 11 is allowed to be displayed or vice versa.

In summary, the present invention downloads the communication data, such as advertisement data or other messages, provided by a server to a computing device, and displays the communication data when the computing device runs a specific procedure. Thus, it is possible to fully exploit the display resources of the computing device and further improves the value of communication and promotion using the computing device.

The aforementioned illustrations set forth the descriptions and drawings of the present invention. The scope of the present invention should be defined by the following claims. All changes or alternations conveniently considered by those skilled in the art without departing from the spirit of the present invention are deemed as being covered by the scope of the present invention.

What is claimed is:

1. A method for message display and transmission in a computing device which is connected to a server, wherein the computing device includes a storage unit and a display device, comprising:
providing at least a set of communication data to the storage unit of the computing device; and
displaying the communication data which should be currently displayed by the display device according to a schedule data and a specific procedure executed by the computing device, in which the schedule data records at least one display date corresponding to the communication data.

2. The method as in claim 1, further comprising:
determining whether or not the storage unit of the computing device already stores the communication data which should be currently displayed according to the schedule data; and
if the storage unit does not store the communication data which should be currently displayed, downloading the communication data which should be currently displayed from a communication database of the server to the computing device and storing the communication data in the storage unit.

3. The method as in claim 1, wherein the specific procedure is a Basic Input/Output System (BIOS) execution procedure, and when the computing device runs the BIOS execution procedure, the communication data which should be currently displayed is simultaneously displayed by the display device in place of an execution screen of the BIOS execution procedure.

4. The method as in claim 1, wherein the specific procedure is an Operating System (OS) preparation procedure, and when the computing device runs the OS preparation procedure, the communication data which should be currently displayed is simultaneously displayed by the display device in place of a preparation screen of the OS preparation procedure.

5. The method as in claim 1, wherein the specific procedure is an Operating System (OS) execution procedure, and when the computing device runs the OS execution procedure, the communication data which should be currently displayed is simultaneously displayed in a display area of the display device.

6. The method as in claim 1, further comprising:
determining whether or not to pre-download the communication data which is scheduled to be displayed but the display date corresponds to the communication data is not arrived yet according to the schedule data;
if the communication data scheduled to be displayed needs to be pre-downloaded, determining whether or not the storage unit stores the communication data scheduled to be displayed;
if the storage unit does not store the communication data scheduled to be displayed, downloading the communication data scheduled to be displayed from a communication database of the server to the computing device and storing the communication data scheduled to be displayed in the storage unit;
determining whether or not the display date corresponding to the communication data which is scheduled to be displayed is arrived according to the schedule data; and
if the display date of the communication data scheduled to be displayed is arrived, displaying the communication data scheduled to be displayed by the display device according to the specific procedure executed by the computing device.

7. A method for message display and transmission in a computing device which is connected to a server, wherein the computing device includes a storage unit and a display device, comprising:
providing at least a set of communication data to the storage unit of the computing device; and
displaying the communication data by the display device according to a specific procedure executed by the computing device.

8. The method as in claim 7, further comprising:
determining whether or not the storage unit of the computing device stores the communication data; and
if the storage unit does not store the communication data, downloading the communication data from a communication database of the server to the computing device and storing the communication data in the storage unit.

9. The method as in claim 7, wherein the specific procedure is a Basic Input/Output System (BIOS) execution procedure, an Operating System (OS) preparation procedure, or an OS execution procedure.

10. A system for message display and transmission, comprising:
a server, including a communication database which stores at least a set of communication data; and
a computing device, connecting to the server through a network connection and having a display device, a storage unit, and a display control unit;
wherein the communication data stored at the server is downloaded and stored in the storage unit through the network connection, and the display control unit determines whether or not to display the communication data at the display device according to a specific procedure executed by the computing device.
